(19) United States
(12) Patent Application Publication
(10) Pub. No.: US 2009/0092281 A1
(43) Pub. Date: Apr. 9, 2009

(54) METHOD FOR IMPROVED FORENSIC ANALYSIS

(75) Inventors: Patrick J. TREADO, Pittsburgh, PA (US); David L. Exline, Gibsonia, PA (US); Julianne Wolfe, Pittsburgh, PA (US)

Correspondence Address: Mark C. Comtois;Duane Morris LLP, Suite 1000, 505 9th Street, N.W., Washington, DC, 20004, US

(73) Assignee: Chemlmage Corporation

(21) Appl. No.: 12/243,683

(22) Filed: Oct. 1, 2008

Related U.S. Application Data
(63) Continuation of application No. 10/698,243, filed on Oct. 31, 2003, now abandoned.
(60) Provisional application No. 60/422,604, filed on Oct. 31, 2002.

(51) Int. Cl. G06K 9/00

(52) U.S. Cl. 382/100; 382/124

(57) ABSTRACT

A method for improved forensic analysis using multi-view digital imaging of forensic specimens at a plurality of reflected, scattered, emitted, transmitted or absorbed wavelengths to provide new detailed information to distinguish and differentiate forensic materials and samples.

### REFERENCE TO RELATED APPLICATIONS

This application claims priority pursuant to 35 U.S.C. § 119(e) to U.S. Provisional Application No. 60/422,604, filed Oct. 31, 2002.

### FIELD OF THE INVENTION

The present invention relates to the field of forensic analysis and, more specifically, to the use of multi-view digital imaging of forensic samples at multiple reflected, scattered, emitted, transmitted or absorbed wavelengths to provide new, detailed information to distinguish and differentiate forensic materials and samples. This method allows more subtle forensic features to be observed and related to the image of the sample or to known reference samples than heretofore possible.

### BACKGROUND OF THE INVENTION

Forensic analysis involves the observation and identification of an object that may exist in part or in its entirety on some sort of supporting surface. This analysis typically compares the sample in question to other possible reference samples or reference data to make an association that relates it to a specific person, place or event. Forensic analysis is widely used in law enforcement or legal disputes as evidence in a range of situations from homicide to fraud. More specifically, the goal is usually to provide evidence of the existence of a direct link, for example, between a suspect and a crime scene, a victim and a suspect, a weapon and a suspect, etc. To do so with a high degree of specificity and discrimination from possible variations of the sample is essential. Examples of forensic samples include, but are not limited to, fingerprints, gunshot residues, condom lubricants, multi-layer paint chips, fibers, ink samples and thin layer chromatography plates.

The quality of a forensic analysis is critical in making the association of evidence as unambiguous as possible, thereby providing compelling identifications and linkages. In many cases, such as with fingerprints, this identification has widely accepted requirements where as in others, such as fiber characterization and comparison, the uniqueness of the results can be disputed. Even the most unique and definitive identification of biological evidence based on genetic information has been successfully questioned and removed as compelling evidence. Minimizing the subjective components or features of a forensic analysis to make compelling identifications and linkages therefore becomes a critical aspect of all forensic analysis. Doing so quickly and in a cost effective manner is equally important.

Advances in science and technology have enabled many new approaches to sample analysis, bringing forensic science into an era which goes far beyond the classic perception of an investigator looking thru a magnifying glass for small traces of evidence. Numerous techniques exist that allow detailed chemical and elemental identification. This includes most all analytical chemistry methods, such as mass spectroscopy, x-ray analysis, scanning electron microscopy and chromatography, that are widely used today to characterize gaseous, liquid and solid materials. Many of these methods are extremely sensitive and require finite material for their use that is consumed as part of the analysis process. Advances in the sensitivity of analytical chemistry methods and instruments over the years have reduced this problem but these methods are still not considered non-destructive. This becomes increasingly important as smaller and smaller pieces of pieces of evidence are examined and required in forensic analysis.

Optical spectroscopy is a type of detection and analysis method that need not destroy a sample and that can often be chemically specific. Infrared (reflection or transmission) spectroscopy, Raman spectroscopy, light polarization spectroscopy and Fourier transform infrared spectroscopy all fall into this category. These techniques carry an advantage in that they can be applied in a non-destructive manner yet obtain rich, detailed information.

For both analytical chemistry approaches as well as the aforementioned optical methods, the analysis is performed on a small piece or a specific region of the sample that is selected for analysis and compared to another reference sample or samples. Essentially, these analysis methods take a measurement at a point or averages over a small region, which is considered to be representative of the sample. Comparisons of different samples is done by taking the measured output from each by the analysis instrument and comparing them. The output for these comparisons is typically a detailed graph of the measured signal as a function of some technical variable, like mass, atomic weight or wavelength. These signals form a complicated line pattern or graph. These patterns or graphs can be rich in detailed features and clearly interpreted by scientific experts. However, the principles of such methods and the resulting graphs can be difficult for other non-experts to interpret or place confidence in. Thus, when presenting this evidence in courtrooms, such techniques may not be sufficiently understood to provide convincing or compelling evidence.

In most legal cases, the ability of a jury or judge to understand the forensic evidence, and the ability of the scientist to convey its value determines the utility of the forensic method. As a result, methods which allow the objects to be visually compared or which show simple representations of the item under scrutiny are the most widely accepted and understood by non-specialists. Despite the existence of many advanced scientific techniques and analysis methods that are very sophisticated, many such techniques may not be understood by non-specialists, and may thereby raise some doubts as to its validity. Visual forensic analysis and visual comparisons are amongst the most widely accepted forensic methods used to date.

Because many forensic analyses generally focuses on visual inspections, advances in this field have focused on providing optimized illumination by using high intensity sources, as in U.S. Pat. No. 5,072,338 (Hug, et al., entitled “Inspection/Detection System With A Laser Module For Use In Forensic Applications”), or variable wavelength, as in U.S. Pat. No. 6,239,904 (Serfling, et al., entitled “Forensic Microscope, In Particular For Examination Of Writing”) as well as enhancing the response from the forensic sample by applying special dyes, as in U.S. Pat. No. 6,485,981 (Fernandez, entitled “Method And Apparatus For Imaging And Documenting Fingerprints”). In the latter case, these dyes allow the forensic material to be enhanced when viewed by certain incident illumination. All of these methods focus on the type and nature of the incident radiation, and, in many cases, to tuning the incident radiation wavelength to optimize the signal for visual inspection. Other forensic examination devices have also employed a particular non-variable wavelength filter to analyze the reflected or emitted light to enhance the contrast of the forensic image. The choice of the particular filter used in such analysis is determined by the particular sample being studied or the particular chemical treatments used by the forensic scientists to enhance features in the forensic sample, such a latent fingerprints.

FIG. 1 shows a general schematic of a typical prior art forensic analysis system. The specimen 1, and reference sample 2, nearby specimen 1 are illuminated with radiation 4 by light source 3, which produces radiation 5, which is reflected from or emitted by specimen 1, and reference sample 2. Light source 3 may or may not be tunable to enhance or accentuate certain features as viewed through the scope or on the sample itself. Usually, the background near the specimen or a calibration object serves as the reference for many measurements. Reflected or emitted radiation 5 may be treated by a conditioning filter 6, and focused via a lens 7, into an optical housing 8, for image capture. In many cases, conditioning filter 6, or filter wheel 9, is used to select a specific wavelength of the light from the sample to obtain a single image at the desired wavelength. Filter wheel 9 is used to accommodate a range of different filters, where each filter is designed and known by those skilled in the art to view different types of samples, for example, one filter for certain fibers, another filter for latent fingerprints, etc. Optical housing 8 typically forms the main body of the forensic platform and interfaces the unit to one or more viewing eyepieces 10, and other image capture devices 11, such as a film, digital camera or video camera.

The prior art systems are designed to produce a single snapshot, video picture or digital image 12, of the forensic sample that documents what the image of the forensic sample looks like at the incident wavelength. This is then visually compared to other reference samples taken under the same instrument conditions.

One difficulty with systems of the prior art is their relative lack of dynamic range and resolution, making it difficult to clearly differentiate small, subtle or minute variations over the forensic sample. Prior art systems produce a single image at a given wavelength or set of wavelengths of emitted radiation, making it impossible to view or obtain data from minute portions or different regions of the overall sample if the emitted radiation varies slightly within the sample or compared to the background substrate or sample matrix.

### SUMMARY OF THE INVENTION

The apparatus and method of forensic analysis of the present invention focuses on creating multiple views of the sample using the emitted, scattered, reflected or absorbed radiation over a wide range of wavelengths in one continuous measurement. Additionally, for each pixel at any given resolution, data representing the intensity of light collected by an image sensor is stored for each wavelength at which a view is collected. These views, at different wavelengths coming off of the sample, form the basis for differentiating the features of a sample that is not possible with a single image snapshot, such as is provided by prior art systems. In some cases, this also involves selecting a particular wavelength or range of wavelengths of incident radiation so that the samples are most likely to respond, for example, the near infrared, ultraviolet, or visible regions. Certain types of samples, for example, fibers or fingerprints, are known by those of ordinary skill in the art to show enhanced reflection, emission or luminescence at particular incident wavelengths, which forms the basis for the selection of a particular incident wavelength for illumination.

In the multi-view approach of the present invention, the reflection, emission or scattering of this incident illumination at a plurality of wavelengths over the entire image of the forensic specimen is examined to create multiple views of the specimen. No tuning of the incident radiation is required to perform this analysis. The multiple views are captured digitally and computer processed to show how the forensic material signals vary at any point (pixel) in the sample over the entire filed of view. These chemical spatial variations can then be processed with a computer to be identified and mapped onto the original image, thereby providing additional clarity over the single snapshot image.

The method of the present invention uses a particular process of wavelength selection and advanced digital image processing to further differentiate and enhance the various features in the forensic sample. These differences represent variations that can exist in the forensic samples themselves, and thereby often require no additional additives or treatment of the samples, unlike conventional methods, which, in many cases, require special processing or treatment to be defined or seen. Further, by differentiating the multi-view image variations and relating these variations to possible references or source samples, we need not identify the specific elements or specific chemicals involved. This simplifies and distinguishes this approach from those that employ chemical analytic techniques, which identify elements, chemicals or compositions.

### BRIEF DESCRIPTION OF THE DRAWINGS

FIG. 1 is a schematic representation of a typical prior art forensic scope.

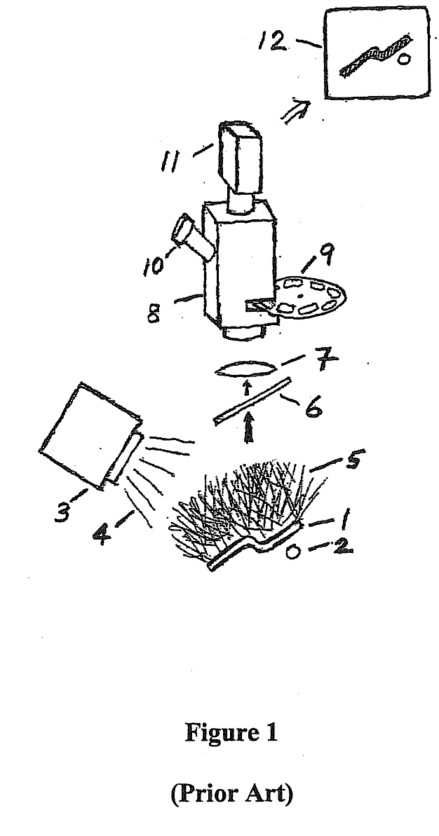

FIG. 2 is a schematic representation of the multi-view forensic scope of the present invention.

FIG. 3 is a schematic representation of examples of multi-views at three different observation wavelengths with the same pixel location selected in each field of view for each multi-view image in this set of multi-view images.

FIG. 4 illustrates a series of computer processed intermediate graphical representations of the pixel intensities for each view (observation wavelength) for the five selected pixels indicated in FIG. 3.

FIG. 5 is a representation of final computer generated multi-view image identifying the different regions of the forensic material in the image for two cases showing two (A) and three (B) distinct components spatially located as indicated. The dashed lines indicate the boundaries between these regions.

FIG. 6 compares a conventional snapshot visible absorption image of white paper treated two months earlier with ninhydrin (A) and the corresponding multi-view processed image (B).

FIG. 7 compares a series of an untreated fingerprints on a paper surface using conventional methods and the multi-view method. An untreated latent fingerprint on paper surface using conventional 35 mm photography (A); the same fingerprint reflectance image developed using the multi-view method employing background comparisons and corrections from the paper (B).

FIG. 8 compares fingerprints on paper aged for 19 years and later developed with 1,8 Diazafluoren-9-one, using the observed luminescence: FIG. 8A is the multi-view image and 8B is the conventional Poliview image.

FIG. 9 shows an image of a black cotton cloth with a bullet hole and some gunshot residue on the surface of the fabric.

FIG. 10 shows the multi-view characteristics of several pixels of one of the observed particles and that of the fabric.

FIG. 11 shows a multi-view image of the gunshot residue propellant.

FIG. 12 compares an optical image of five red cotton fibers (A) and three visible absorption multi-view images at different emission wavelengths (B, C, and D).

FIG. 13 shows the visible absorption multi-view imaging characteristics of five red cotton fibers.

FIG. 14 shows an optical image (A) and two fluorescence multi-view images at 580 nm (B) and 650 nm (C) of three synthetic fibers.

FIG. 15 shows the distinct multi-view characteristics of the three fibers shown in FIG. 14.

FIG. 16 shows examples of multi-view imaging of clear tape backing.

FIG. 17 compares several dispersive Raman spectra of condom lubricant reference samples.

FIG. 18 compares several dispersive Raman spectra of a reference mixture and condom samples.

FIG. 19 shows two optical reflectance snapshot images (A and B), along with multi-view image of two components in the “Beyond 7” brand condom lubricant.

FIG. 20 shows the multi-view characteristics of two components in the “Beyond 7” brand condom lubricant used to obtain the multi-view images of these different components shown in FIGS. 19C and 19D, respectively.

FIG. 20 shows a normal optical reflectance snapshot (A) and multi-view images (B and C) of raw “Trojan” brand condom lubricant.

FIG. 22 shows an optical image of a particle (A) in condom lubricant and a multi-view image (B) of the regions that exhibit the multi-view characteristics for CaCO₃

FIG. 23 is a table of R_{F} values for the specimens of FIG. 24.

FIG. 24 shows a macro colorimetric TLC plate image of various inks and a multi-view analysis of the TLC image demonstrating the improved determination of R_{F} values.

FIG. 25 shows a macro colorimetric TLC plate image of various inks and a multi-view analysis of the TLC image demonstrating the improved discrimination of the colorimetric information specified TLC bands using the multi-view characteristics.

FIG. 26 shows a macro colorimetric TLC plate image of various inks and a multi-view analysis of the TLC image demonstrating the improved discrimination of for specified TLC bands.

FIG. 27 shows a normal optical snapshot of an ink sample with a region of overlapping horizontal and vertical lines enlarged for further multi-view comparisons.

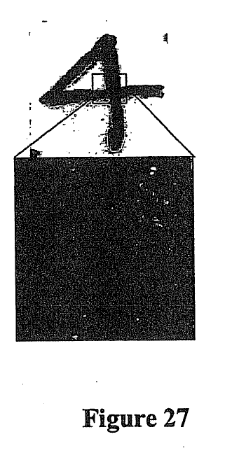

FIG. 28 shows the multi-view characteristics of pixels in the vertical (A) and horizontal (B) sections of the ink line in FIG. 27, which identify differences in these ink lines.

FIG. 29 shows multi-view images which show the pixels and images characteristic of the multi-view characteristics A and B shown in FIG. 28 respectively.

FIG. 30 illustrates a brightfield image of a multi-layered paint chip (A) and compares several multi-view images of multi-layered paint fragments (B through D).

### DETAILED DESCRIPTION OF THE INVENTION

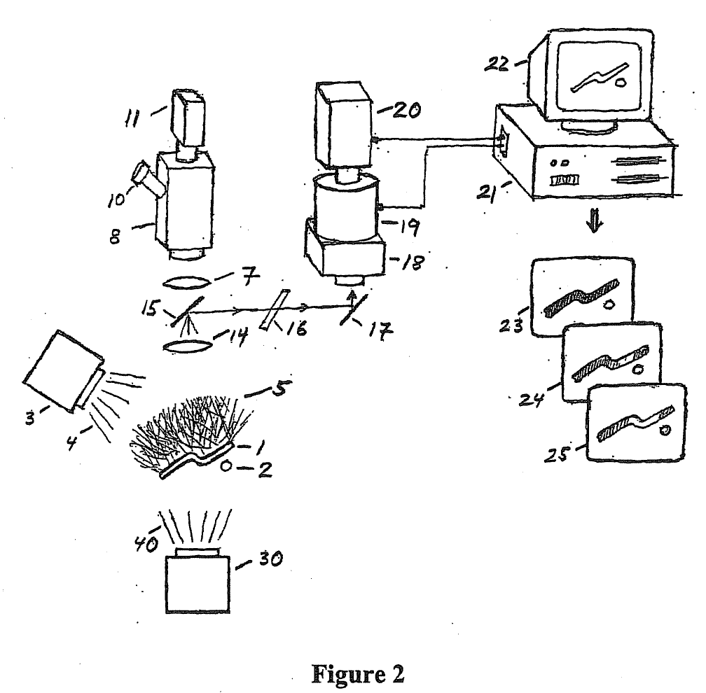

FIG. 2 shows a schematic of the multi-view forensic scope of the present invention. The scope of the present invention consists of multi-view optical train 18, electronic view selector 19 and image sensor 20. Multi-view optical train 18 accepts the sample light and matches its spatial characteristics to electronic view selector 19, the output of which is captured by image sensor, 20. Mirrors 15 and 17 direct radiation which is emitted, scattered or reflected from specimen 1 into the multi-view scope. An optional intermediate filter 16 can be used to filter out certain undesirable components from the scattered, emitted or radiated radiation to optimize the performance of the multi-view optical train 18. Computer 21 controls electronic view sensor 19 and collects data from image sensor 20 for storage and processing. Images of the processed data are rendered on display 22. The multi-view scope configuration shown in FIG. 2 allows for sample viewing with a conventional forensic scope with a movable mirror 15 inserted to deflect the radiation 5 from the sample 1 into the multi-view optical train, electronic view selector and image sensor. An optional configuration would directly accept the sample radiation, 5, into the multi-view optical train 18, electronic view selector 19 and image sensor 20 thru a focusing lens similar to 14 and a conditioning filter 16 directly between the sample 1 and the multi-view optical train 18.

Images 23, 24 and 25 in FIG. 2 represent views of specimen 1 at varying wavelengths of emitted, scattered or reflected radiation 5. Specimen 1 and reference 2, are illuminated by radiation 4 emitted by a light source 3, which, unlike many forensic scopes, need not be tunable due to the use of electronic view selector 19. In general the light source used for the multi-view scope can cover a larger range, approximately 200 nm to 2000 nm, than a conventional forensic scope. For forensic analysis using transmitted light, a different orientation of the light source 30, and illumination 40, are used. Emitted, scattered or radiated light 5 from specimen 1 and reference 2 is collected and focused via light gathering optics 14.

In general, the sample size determines the choice of light gathering optics 14. For example, a microscope lens will be employed for the analysis of sub-micron to millimeter dimension specimens. For larger objects in the range of millimeters to meter dimensions, macro lens optics are appropriate.

Electronic view selector 19 can be an electro-optical tunable filter such as a liquid crystal tunable filter (LCTF) or an acousto-optical tunable filter (AOTF). These filters allow specific wavelengths or ranges of wavelengths of light to pass thru as an image, depending on the electrical control voltages placed on the device by computer 22. The bandwidth or range of the wavelengths passed by this device can be as small as 0.1 nm n or as large as 20 nm or greater. The choice of which device to use depends on the optical region used and/or the nature of the sample being analyzed. The wavelengths that can be passed through electronic view selector 19 range from 200 nm (i.e., the ultraviolet) to 2000 nm (i.e., the far infrared). In some instances, multiple electronic tunable filters may be used to cover the entire range of desired wavelengths.

Image sensor 20 is a digital device, typically a two-dimensional, imaging focal plane array (FPA). The optical region employed to characterize the sample of interest governs the choice of FPA detector. For example, silicon charge coupled device (CCD) detectors, a type of FPA, are employed with visible wavelength fluorescence and Raman spectroscopies, while gallium arsenide (GaAs) FPA detectors are typically employed for image analysis at near infrared wavelengths. The choice of these detectors depends on the type of forensic analysis desired. The imaging sensor produces digital images of the entire view of the forensic sample as processed by electronic view selector 19.

Both electronic view selector 19 and image sensor 20 are controlled and read by a computer 21, preferably a personal computer (PC), and displayed on display 22. A few schematic examples of the multi-view images obtained at different viewing wavelengths are shown as 23, 24 and 25. In most cases, the changes are smaller than those portrayed in this example, which is intended only as a schematic exemplar. Computer 22 and display 21 allows the user to interface, control, process and view the multi-view information from the forensic specimen 1 under investigation.

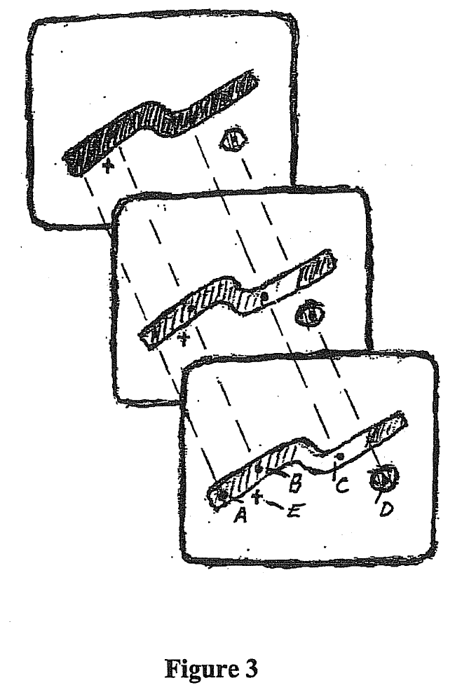

The computer processing of the multi-view information consists of converting the multi-view images into graphical representations of the intensity versus collected wavelength from any part, region or individual pixel element of the forensic sample, so as to determine the multi-view characteristics of these elements of the forensic sample. Typically all pixel elements in a picture are acquired and analyzed at one time, because, in many cases, it is not known which region or pixels in the field of view will turn out to be the most important or useful. As an example, FIG. 3 indicates five pixels, A, B, C, D and E being analyzed that correspond to the same location in each of the multi-view images. Pixels A, B and C correspond to pixels on the forensic specimen 1; pixel D corresponds to some reference object 2 in the field of view; and pixel E corresponds to a location nearby the sample, referred to as the background. These pixel sizes can range from submicron to millimeters dimensions depending on the magnification, sample and illumination used. In terms of resolution, a typical CCD used as image sensor 20 may have a resolution of 1024×1024 pixels, for a total of 1,048,576 pixels for each wavelength at which a view is captured. In typical operation, a range of wavelengths will be captured at a predetermined increments, based on prior art knowledge of the specimen and the type of discrimination needed for the particular forensic analysis.

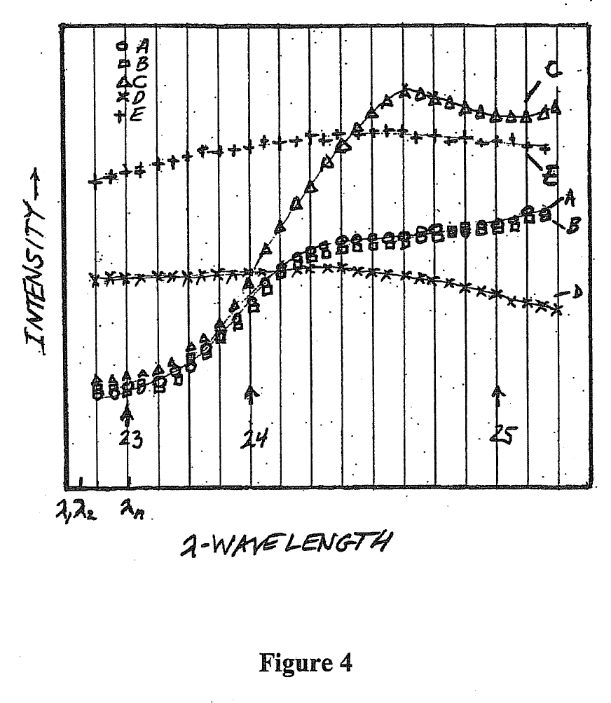

As shown in FIG. 4, computer 22 creates a graph of the intensities of pixels A-E as a function of the wavelengths of the emitted, scattered, transmitted or reflected light which were captured by image sensor 22. Such graphs occur for each of the million plus pixels in the image and become part of the detailed analysis and comparisons done by computer 22 to identify and tag similar or different multi-view characteristics of these pixels. Such data will typically show more scatter or noise than illustrated in FIG. 4, which can be accounted for by the computer in the identification of the differences in the multi-view variations. Use of the background variations as a reference signal also becomes particularly important to enhance or resolve subtle variations or differences in forensic samples that arise on a surface, such as a fingerprint. In many cases, computer 22 can rapidly search a database to find similar multi-view patterns to identify equivalent or related objects.

These intensity graphs of each pixel of the multi-view image are analyzed to define the variations in the emitted, reflected, transmitted or scattered light at every single pixel. All three pixels A, B, and C on specimen 1 have similar characteristic variations up to multi-view 24, which is a view at a particular wavelength (not specified), and at higher wavelengths only pixels A and B show similar characteristics. All are clearly distinguished in this example from the background sample E or reference sample D, which need not generally be the case. The computer processing of all pixels in this set of multi-view images would tag these pixels as well as identify those to known objects.

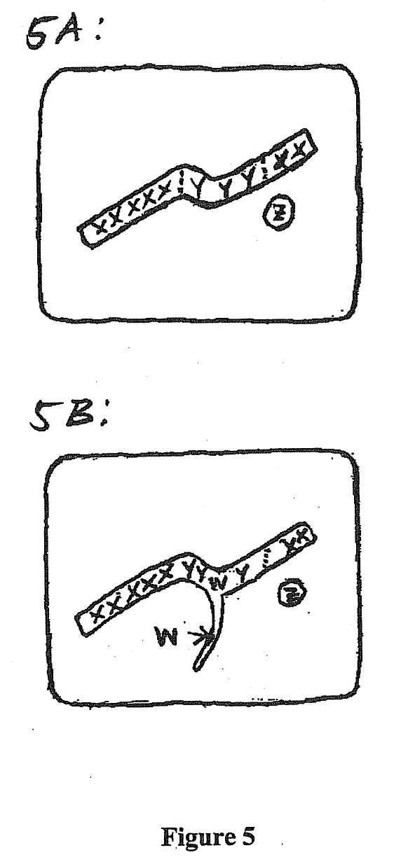

FIG. 5A shows a schematic representation of the final result of a multi-view analysis of the forensic sample discussed in FIGS. 3 and 4. Here, pixels in the central area of the sample show the multi-view features of pixel C of FIG. 3, and the area labeled as ‘Y’ in FIG. 5A. The other areas of the sample representative of pixels A and B of FIG. 3 are indicated as ‘X’ in FIG. 5A. These different multi-view characteristics may be associated with the variability of environmental, history and/or manufacturing influences, which becomes critical to the forensic analysis.

As an alternative to a graphical representation of each pixel, a more desirable mode of presenting these multi-view results is to color code similar pixels and overlay them onto the original image to visually distinguish these differences. In some cases, such as in two component systems, the multi-view image can be in black and white and will appear as a sharper more distinct, clearly defined image of the original sample, because more information has been detected and processed with the multi-view approach.

In more complicated cases schematically shown in FIG. 5B, a weak additional feature, labeled as W, may be observed that indicates yet another material not detected in the original forensic snapshot. Reference samples may further help to identify the nature or possible origin of this material. To aid in a more detailed evaluations, multi-view analysis using Raman scattering is possible, which generally provides richer multi-view features than shown in FIG. 4.

This invention collects and utilizes high definition digital images processed by an electronically controlled view selector 19 over a wide range of wavelengths of scattered, emitted, or reflected light from a forensic specimen 1 so as to provide multiple views of the specimen that are computer processed to differentiate minute features. Prior art forensic scopes do not allow nor facilitate such a capability. Other commercially available analytical instrumentation used to analyze the continuum of scattered or reflected light in detail as done with this device are typically performed in a point or line scanning mode, which is more time consuming and has limited spatial resolution due to the size of the spot probes used. These spot focused methods also concentrate the incident radiation and are thereby more likely to damage the sample. These instruments are typically analytical chemistry instruments that are not optimized for forensic applications.

The way the intensity of the forensic specimen or portions of the specimen vary from view to view creates a signature of the type or origin of the sample. Such multi-view signatures are very distinct and depend in many cases on subtle intrinsic properties of the sample, including its history or method of manufacture, which is not generally discernable using the single view snapshot method of forensic analysis widely used today. Such multi-view capability allows this invention to work even with difficult backgrounds, for example, fluorescent substrates, dark substrates, rough substrates and multicolored substrates.

### EXAMPLE APPLICATIONS OF THE INVENTION

Note that in all of the example applications which follow, the electronic view selector 19 is a liquid crystal electro-optical tunable filter, while image sensor 20 is a charge coupled device having a resolution of 1024×1024 pixels. For those examples requiring white light illumination, a CrimeScope, manufactured by Spex Forensics, was used. For the samples requiring laser excitation, a 532 nm laser was used, however, the laser excitation may vary depending on the sample of interest.

### Fingerprints

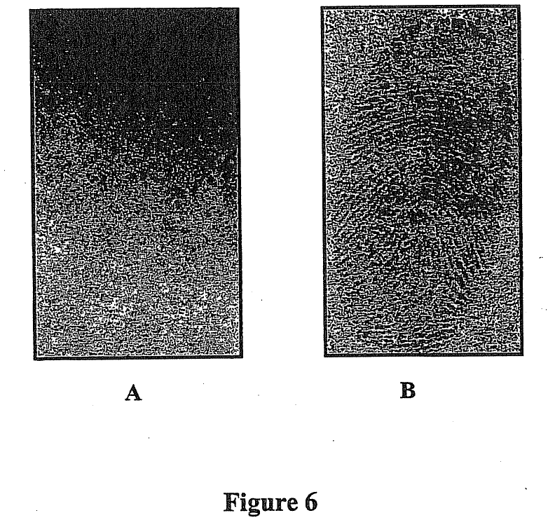

These examples describe the general setup and analysis for visible reflectance multi-view imaging of fingerprints on a macroscopic platform. In the first example, shown in FIG. 6, the sample is illuminated using white light. The multi-views were acquired for the sample at wavelengths from 490 nm to 620 nm, in 5 nm increments. FIG. 6A shows a latent fingerprint present on white paper treated with ninhydrin two months earlier as photographed using a AxioCAM HRM digital camera. This is a typical approach used for enhancing and visualizing fingerprints by chemical treatment and conventional snapshot methods. FIG. 6B shows a processed multi-view image that is able to pick out more detailed features of this fingerprint. This is obtained by taking the series of multi-view images, defining a wavelength region that appears to best show the print, using the multi-view features of these regions over this range of wavelengths to confirm these as regions of the print. Then, to correct for the background signal from the paper, pixels are taken nearby the fingerprint, and, for each multi-view image, these pixels are subtracted in each of the other images. Such subtraction creates greater contrast in the multi-view images. Additional background corrections are sometimes needed to account for non-uniformities of illumination, in which case several different points nearby the fingerprint can be selected over the wide field of view and interpolated to form a spatially varying background over the field of view, which is then subtracted from each multi-view image from which they were derived. After the background corrections each pixel in the resulting chemical image was subtracted by a global minimum value to reduce offset, and then a vector normalization procedure was performed. Vector normalization involves dividing each pixel spectrum by the square root of the sum of the squares of all the pixel spectra, which has the effect of bringing intense image features to approximately the same scale as weak image features. Selecting and identifying the pixels with multi-view characteristics of the fingerprint from the normalized data produces the improved fingerprint image 6B. The use of the multi-view variations with wavelength to identify pixels corresponding to the fingerprint further enhances this contrast.

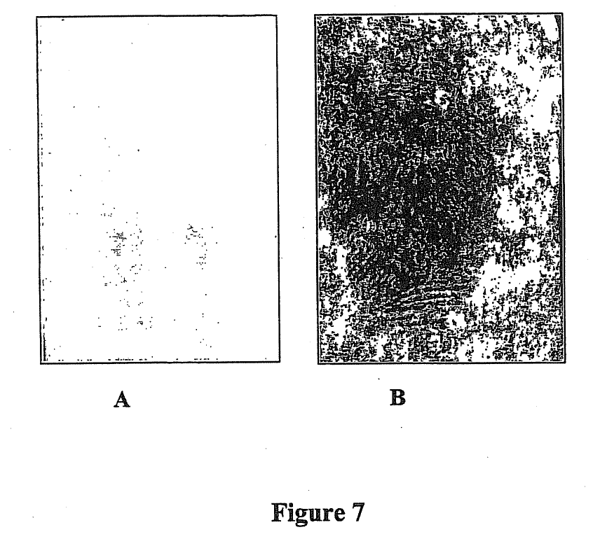

The second fingerprint example, shown in FIG. 7, describes the visualization of untreated latent fingerprints on white paper, which is not attainable using conventional visualization methods. The sample is illuminated using white light. The views of the fingerprint are obtained from wavelengths varying from 420 nm to 720 nm in 10 nm increments. FIG. 7A shows a conventional white light snapshot image of the latent fingerprint. FIG. 7B shows a visible reflectance multi-view image of the fingerprint produced after a background correction to the multi-view data followed by subtraction of the global minimum and vector normalization as described in the previous example. The image shown in FIG. 7B was extracted from the multi-view image at 490 nm. In this multi-view image analysis, the multi-view images are divided by several regions of pixels in each multi-view image not associated with the fingerprint, i.e., an interpolated background correction for each pixel of the multi-view images. This background corrected image is shown in 7B. Such background variations arise over the image due to variations of the illumination light source, substrate reflectance and instrument response. Further contrast can be achieved by then performing an analysis of the multi-view intensities to define all those pixels characteristics of the print and mapping these pixels out in an image. In many cases, sufficient contrast is obtained to more clearly resolve the fingerprint by performing these background corrections and looking at the multi-view image that shows the highest contrast. The application of a full multi-view intensity analysis can further enhance those pixels characteristic of the fingerprint material.

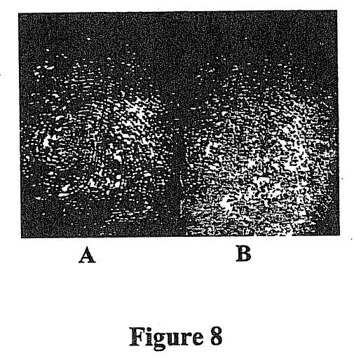

The examples shown in FIG. 8 are luminescence-derived images of a 19-year-old 1,8 Diazafluoren-9-one (DFO) treated fingerprint on white paper. The sample was excited using 550 nm excitation light. The views are obtained at wavelengths from 560 nm to 720 nm in 10 nm increments. The multi-view images are first corrected as described earlier for the background and then the multi-view pixel identification of the fingerprint pixels is performed based on all the images collected between 580 nm and 650 nm. The result is shown in FIG. 8A. FIG. 8B shows the same DFO treated fingerprint visualized a using a single barrier filter at 610 nm, which represents the state of the art snapshot approach.

### Gunshot Residue

This example describes the general setup and analysis for macroscopic imaging of surfaces having suspected gunshot residue deposition. This specific sample consists of a piece of black cotton fabric which has been hit by a bullet fired from a distance of 12 inches away. Upon optical examination, one can see particulates if the fabric is white, but for darker fabrics, the particulates become very difficult to distinguish from the background cloth. In general, other particulates from the environment also may be present (for example diesel soot or organic debris in the environment).

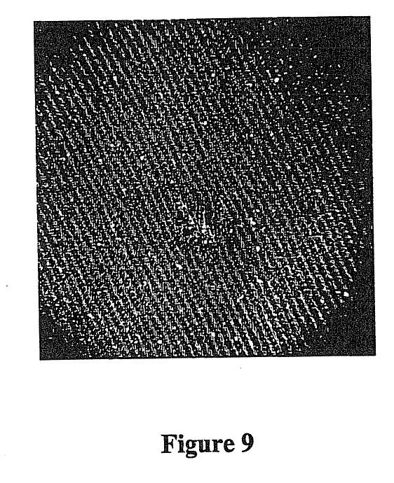

FIG. 9 shows an image of the bullet hole. Using an illumination source set to 450 nm, data was collected through the multi-view selector using a range of wavelengths from 520 nm to 720 nm in 20 nm increments and processed using the described data processing methods. The image in FIG. 9 was taken with the multi-view selector dataset viewed at a wavelength of 520 nm, which looks very similar to direct observation with white light or observation under a conventional microscope. A few particles are observed, but are difficult to distinguish from the background substrate.

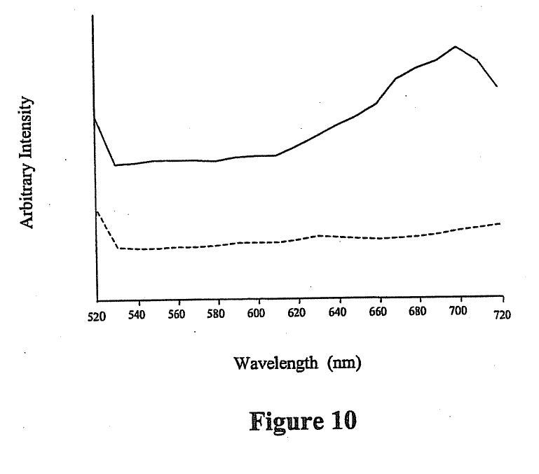

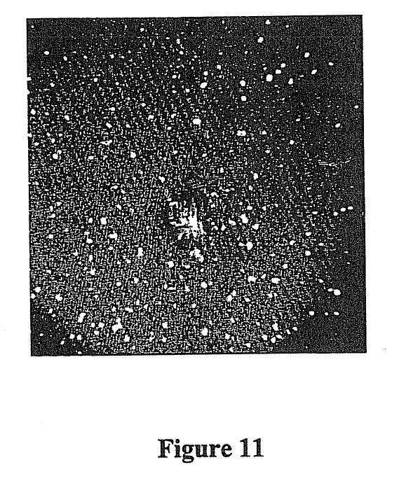

With respect to the particles shown in the FIG. 9, it can be determined which of the particles are gunshot residues and, in addition, their concentration, which is an indicator of firing distance. The multi-view characteristics of the pixels comprising potential gunshot residue related particles are shown in FIG. 10 as the solid line. From reference measurements it is known that this multi-view characteristic is consistent with this particular ammunition's propellant composition. The multi-view characteristics found by moving off this region onto the fabric is indicated by the dashed line which clearly differs from that of the particles. By using the multi-view characteristics of known gunshot particles we can reconstruct those multi-view pixels associated with these residues to accurately determine their locations, density and size distributions. Shown in FIG. 11 is the multi-view image selected at a wavelength of 700 nm, which, after proper background subtraction and image processing, readily characterizes the gunshot residue propellant.

### Fiber Identification

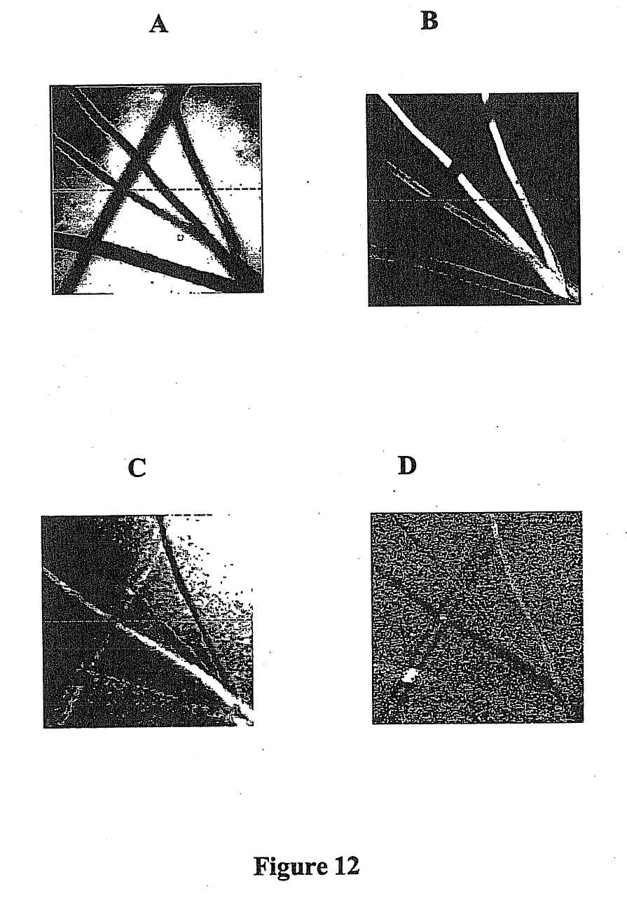

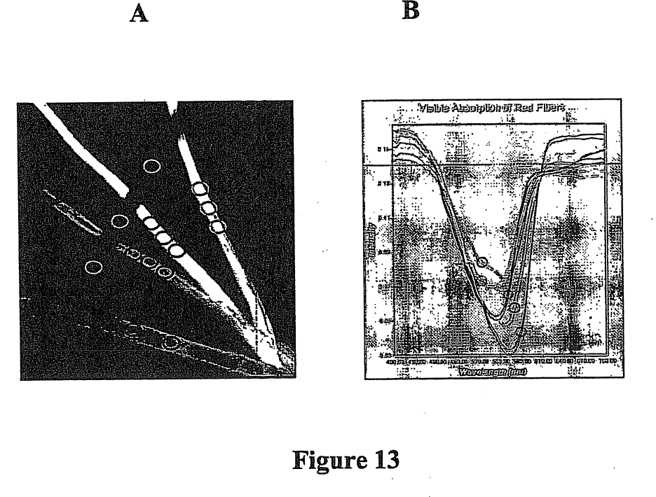

These examples describe the general setup and analysis for visible absorption and fluorescence multi-view imaging of different types of fibers on a macroscopic platform. The first example describes microscopic visible absorbance multi-view imaging of natural and synthetic fibers. A microscope with a tungsten-quartz-halogen light source in the transmission mode constitutes the base of the instrument setup. FIG. 12 shows comparisons of five red cotton fibers viewed in the optical region (A) as well as at other wavelengths (B, C and D) with the multi-view approach. The multi-view imaging dataset was collected a range of wavelengths from 400 nm to 700 nm in 5 nm increments. Three groups of pixels on each of the fibers were selected as shown in FIG. 13A and their multi-view characteristics plotted in FIG. 13B. In this case, a multivariate statistical analysis was used to distinguish pixels with similar multi-view features as part of the multi-view analysis. Each of these five fibers can be easily discriminated as shown by the multi-view characteristics. FIG. 13 shows the resulting imaging spectrometer spectra, demonstrating the variable visible absorbance spectra of the five samples as well as the reproducibility of the spectra within the same fiber.

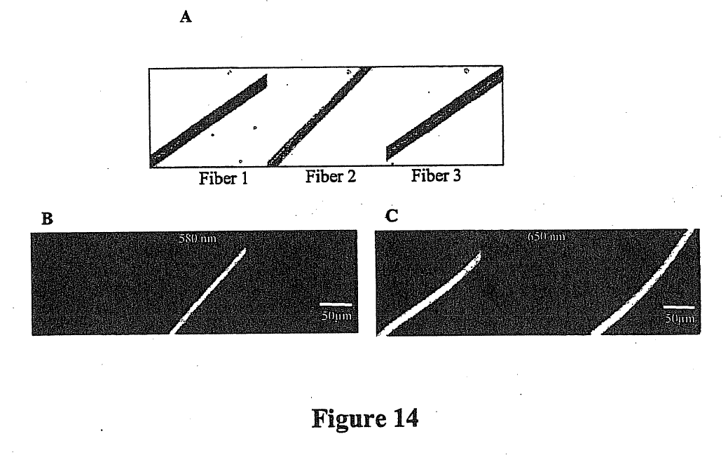

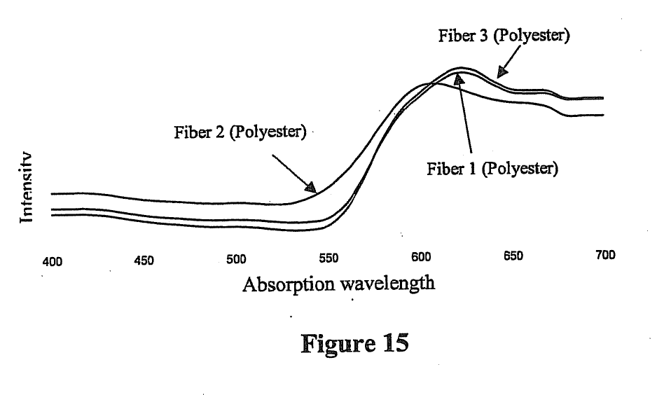

In the second example, microscopic fluorescence multi-view results of natural and synthetic fibers is shown. A microscope with a mercury light source in the reflectance mode constituted the base of the instrument setup. FIG. 14A shows an optical image. An interchangeable fluorescence cube composed of a 420 nm excitation filter, 420 nm dichroic mirror and a 430 nm band pass filter was utilized to filter the light passing through multi-view image selector 19. Multi-view images were acquired by electrically controlling the electro-optic tunable filter for wavelengths from 440 nm to 720 nm in 5 nm increments. The corresponding fluorescence emission seem in a few multi-view results are shown in FIGS. 14B and 14C for 580 nm and 650 nm respectively. The multi-view characteristics allow clear delineation of the synthetic fibers as shown in FIG. 15.

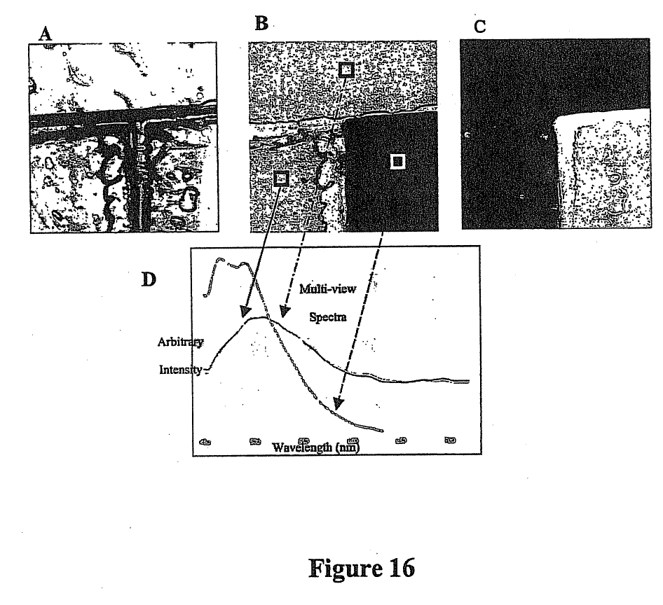

These examples demonstrate that fluorescence multi-view imaging is an efficient characterization method for similar fibers and removes the subjectivity inherent to the current methods of fluorescent fiber characterization and comparison. We also find that such fluorescence multi-view imaging also works well to identify and characterize different transparent adhesive tapes as shown in FIG. 16. FIG. 16A shows a snapshot optical image, multi-view images at 655 nm and 440 nm are shown in FIGS. 16B and 16C respectively, while the resulting multi-view characteristics showing the distinct pattern for the adhesive tape are shown in FIG. 16D. The region seen in 16C and it's distinguishing multi-view features shown in 16D clearly reveal that this tape differs from the other two tapes in the image 16A.

### Condom Lubricants:

Commercially available condoms are primarily manufactured of latex and, to a lesser degree, polyurethane and sheep ceacum. All three types can contain fine powders, lubricants, and/or spermicides in various combinations.

Lubricants are generally divided into two categories. Wet lubricants are water based, commonly polyethylene glycol (PEG) or propylene glycol (PG). Dry lubricants are typically silicone oils, the most common being polydimethylsiloxane (PDMS). Nonoxynol-9 (N9) is by far the most widely used spermicide. It can be found in conjunction with both wet and dry lubricants and can compose 5-15% of the lubricant mixture. Condoms may also contain fine particulate components that are used to prevent the sheath from sticking to it when unrolled. These may include talc, cornstarch (or other starches), CaCO₃, powdered silica, MgCO₃, or lycopodium.

These examples describe the general setup and analysis for Raman scattering multi-view imaging of condom lubricant material on a microscopic platform. For the cases of identifying condom lubricants, a laser with high intensity at a single wavelength is preferred. In this case a blocking filter is used to attenuate the diffuse reflected laser light at its original wavelength.

A FALCON™ Raman Chemical Imaging System, manufactured by ChemImage Corporation, of Pittsburgh, Pa., equipped with 532 nm laser excitation and a 100 W quartz tungsten halogen (QTH) broadband source was used to collect brightfield microscopic images, Raman multi-view images and dispersive Raman spectra. Such dispersive Raman spectra provide a useful comparison to conventional Raman as performed for routine analytical chemical analysis. Specially developed software was used for data acquisition, analysis and visualization of the multi-view data. The multi-views are acquired for a condom lubricant sample using a range of wavelengths from 540 nm to 635 nm in 8 cm⁻¹ increments. Data for the calculated images was collected using ChemAcquire 6.0 software, with subsequent analysis, processing and visualization using ChemAnalyze 6.0 software, both manufactured by ChemImage Corporation of Pittsburgh, Pa.

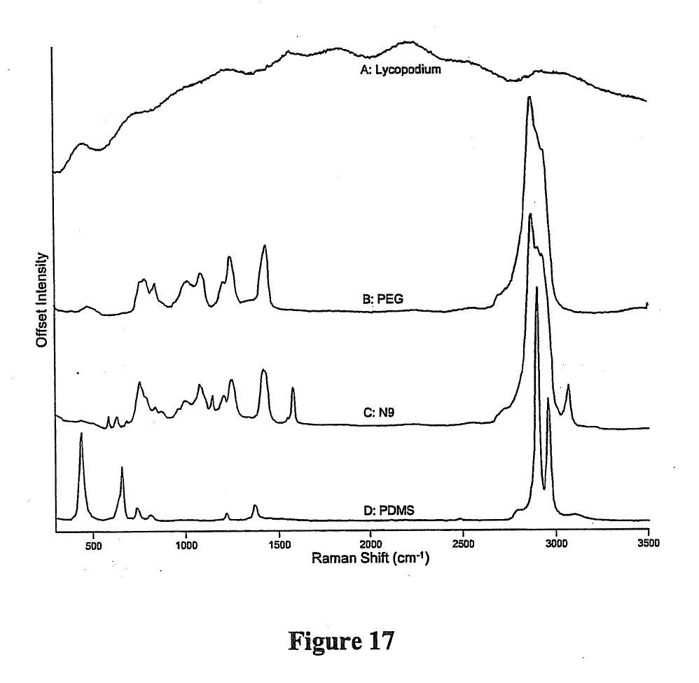

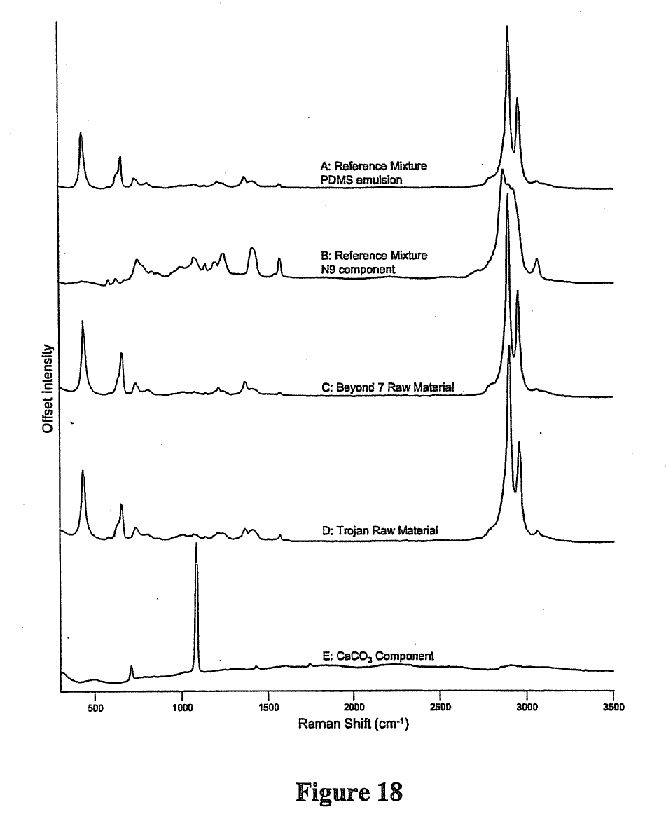

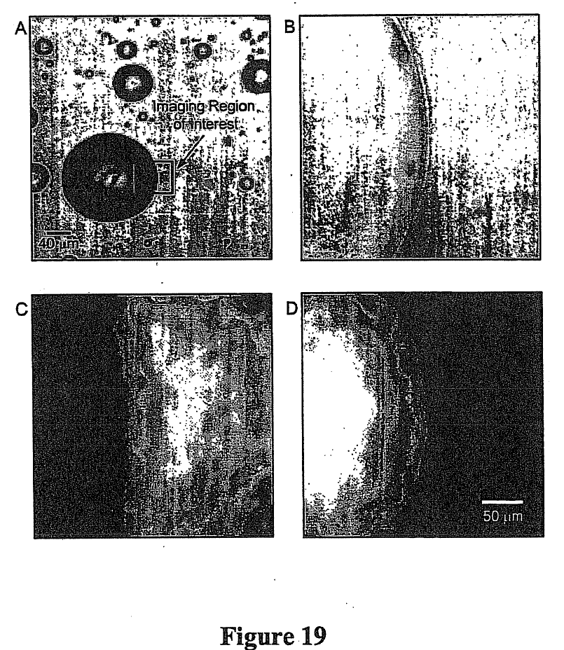

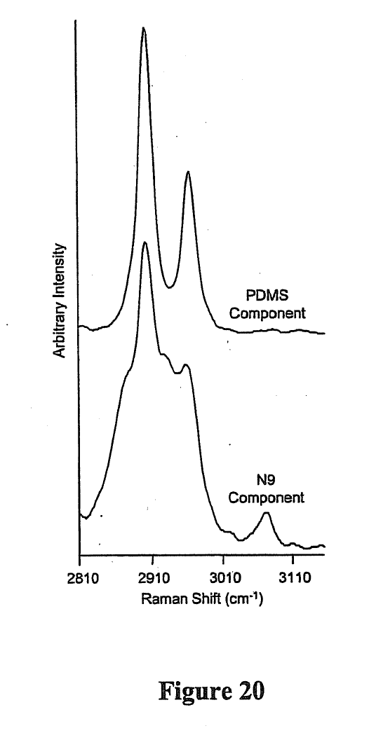

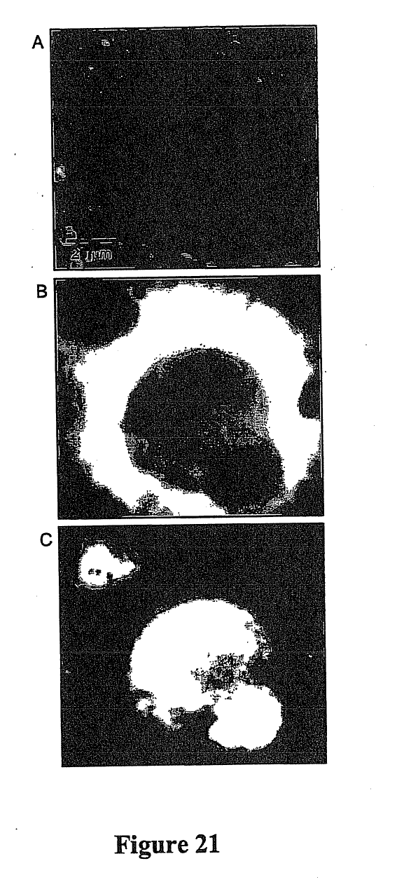

FIG. 17 shows dispersive Raman spectra, which indicates how the Raman scattered light, varies for a variety of different pure components in condoms. This shows strong differences in these spectral variations and suggests that using these emitted wavelengths to identify components in a mixture would be possible. FIG. 18 similarly shows mixtures of these components and that separating these components from such dispersive Raman spectra can become much more complicated than in their pure unmixed forms. FIG. 19 shows how the multi-view analysis can separate several of these various components and identify them within a forensic image. FIGS. 19A and B show visible reflectance ‘snapshot’ images at low and higher magnification (×20). Using the multi-view characteristics of reference samples of PDMS and extract N9 for emitted light between 625 nm and 636 nm, the multi-view identification of these components in the original image is made. FIG. 19C reveals the PDMS and 19D reveals N9 extract. The PDMS shown in 19C which is not even visible in the optical snapshot 19A or 19B. The multi-view characteristics of the specimen that were used to separate them and form the image in FIGS. 8C and 8D are shown in FIG. 20 and cover a range of wavelengths from 625 nm to 632 nm. Similarly, FIG. 21 shows a snapshot image of Trojan brand condom lubricant images (A) and multi-view analysis resolving the different locations of the components of PDMS and N9 in these multi-view images, 21B and 21C, respectively. In this case multi-view characteristics in two ranges of emission wavelength were used: 580 nm through 582 nm and 625 nm through 637 nm.

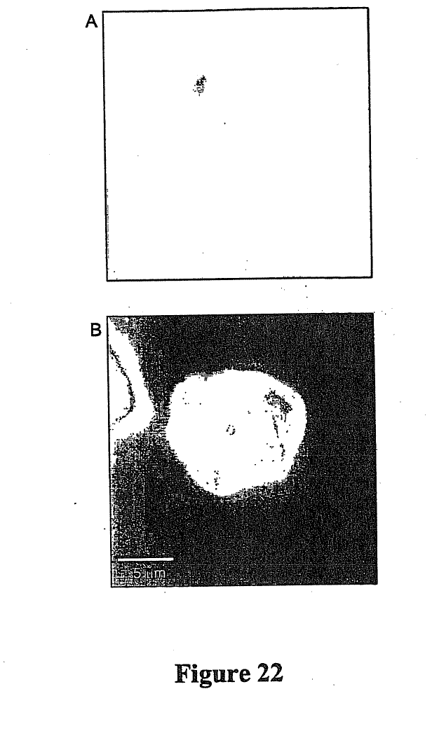

Intrinsic particulate matter of the condom lubricant can also be detected, and images such as CaCO₃, can be obtained as shown in FIG. 22. FIG. 22A shows an optical snapshot while the multi-view analysis reveals the multi-view features indicative of CaCO₃. The pixels having multi-view features of this material are then highlighted in the image of 22B, which is used to characterize such particles, even in the presence of other nearby components.

### Thin Layer Chromatography

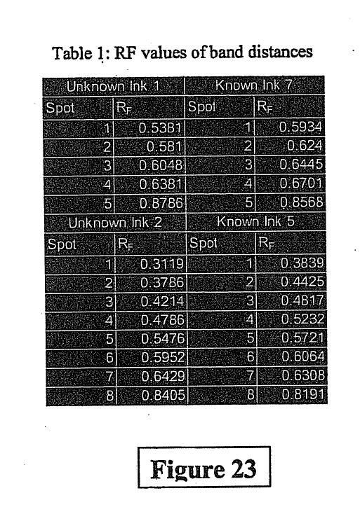

Thin layer chromatography (TLC) is a well-accepted method in forensic science. The analysis of thin layer chromatography plates is routinely conducted for forensic samples such as ink, dyes, explosives and drugs to mention a few. The value of thin layer chromatography lies in its ability to separate the various components of a complex matrix into a discernible pattern of bands (called band profiles) which are indicative of the material. Developed TLC plates can be compared against the band profile of known materials to assist in the association of an unknown material with a known exemplar. Information gained from a typical TLC plate is the R_{F} value (i.e. the distance a specific band component travels relative to distance the distance traveled by the solvent system) and the color of the specific bands. Some typical results obtained from our multi-view analysis are shown in FIG. 23.

Multi-view analysis of the bands removes much of the subjectivity inherent to conventional TLC plate visualization. Software can be utilized to exactly determine the migration of bands, unlike simple measurements with a ruler. In addition, the calorimetric and fluorescent multi-view profiles of the bands are simultaneously determined for each band in the field of view, eliminating time consuming point spectroscopy inherent to conventional methods. In essence, the R_{F} value of band, the colorimetric profile and/or the fluorescence profile can be analyzed simultaneously, increasing efficiency of the analysis and removing subjectivity. Lastly, because all the relevant information for all bands within a TLC plate are collected simultaneously, database structures can be developed to search on multiple levels of each band which increases search capability while removing time consuming manual search methodologies.

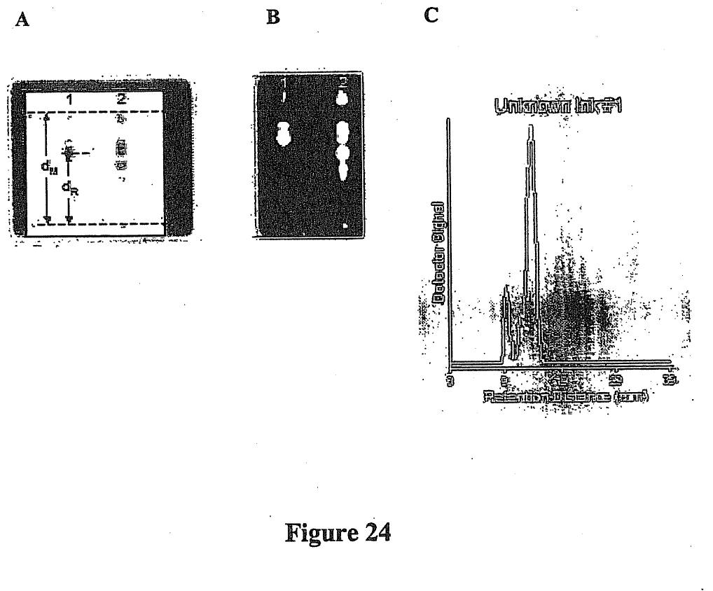

These examples describe the general setup and analysis for visible reflectance multi-view imaging of thin layer chromatography plates on a macroscopic platform. In the first example, the specimen is illuminated using white light. The multi-views are acquired for a thin layer chromatography plate ink specimen #1 with a range of wavelengths from 420 nm to 720 nm in 10 nm increments. Data for the calculated images was collected using acquisition software and digitally stored for viewing and processing. FIG. 24A shows thin layer chromatography plates of ink specimen #1. For the multi-view image shown in 24B, a background correction, cosine correlation analysis and an inversion of the image were employed to produce the resulting image of specimen #1. R_{F} values of specimen #1 are shown in Table 1 in FIG. 23 and were determined by selecting a line through the entire band profile for the sample using data processing software. FIG. 24C shows the resulting band profiles and distances relative to each corresponding band of specimen #1.

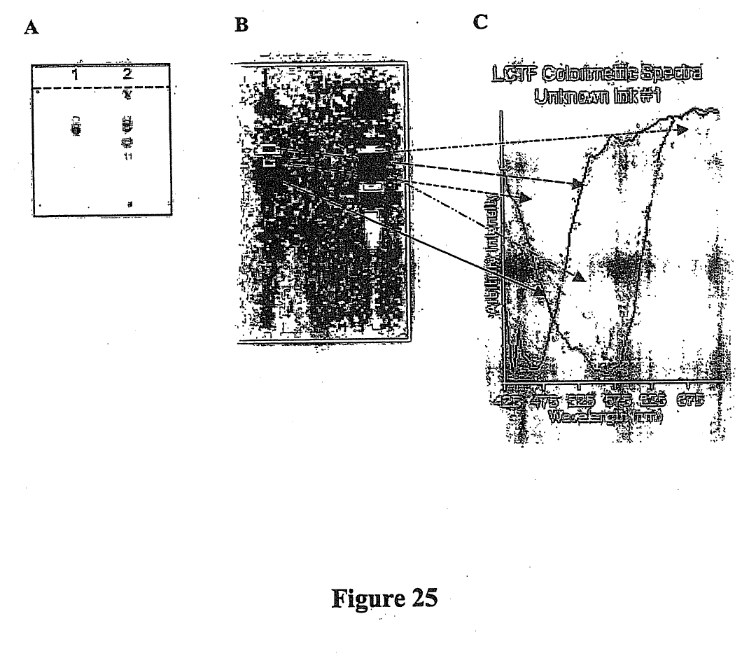

In a second example, the specimen is illuminated using white light. The multi-views are acquired for a thin layer chromatography plate ink sample in a range of wavelengths from 420 nm to 720 nm in 10 nm increments. FIG. 25A shows thin layer chromatography plates of ink specimen #1 prior to analysis. For the multi-view image shown in 25B, a background correction, bias correction, subtraction of “darkest” image extract followed by dividing the “brightest” image extract of the overall image were employed to produce the resulting image of specimen #1. Multi-view image selector spectra of the resulting bands were determined by selecting a region within each bank for each sample profile using data processing software. FIG. 25C shows the resulting multi-view characteristics or ‘spectral profiles’ relative to each corresponding band for specimen #1. These strong multi-view variations of each of these bands provide greatly improved discrimination over previous ‘snapshot’ methods.

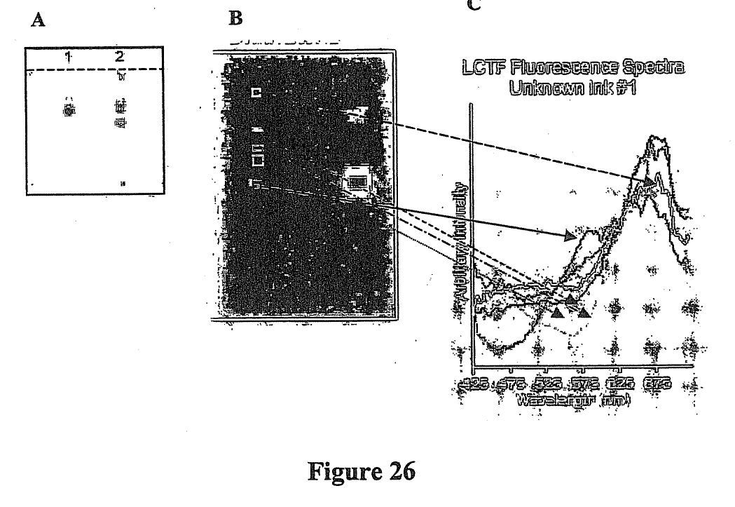

In the third example, the specimen is illuminated using 300-400 nm excitation light. The multi-views are acquired for a thin layer chromatography plate specimen #1 in a wavelength range from 420 nm to 720 nm in 10 nm increments. Data for the calculated images was collected using acquisition software and digitally stored for viewing and processing. FIG. 26A shows thin layer chromatography plates of ink sample #1 prior to analysis. For the multi-view image shown in 26B, a background correction, bias correction, subtraction of “darkest” image extract followed by dividing the “brightest” image extract of the overall image were employed to produce the resulting image of specimen #1. Multi-view image selector spectra of the resulting bands were determined by selecting a region within each bank for each sample profile using data processing software. FIG. 26C shows the resulting multi-view features or emission ‘spectral profiles’ relative to each corresponding band of specimen #1. These wide variations of the various TLC bands provide unique features to better identify corresponding forensic samples.

### Ink Identification

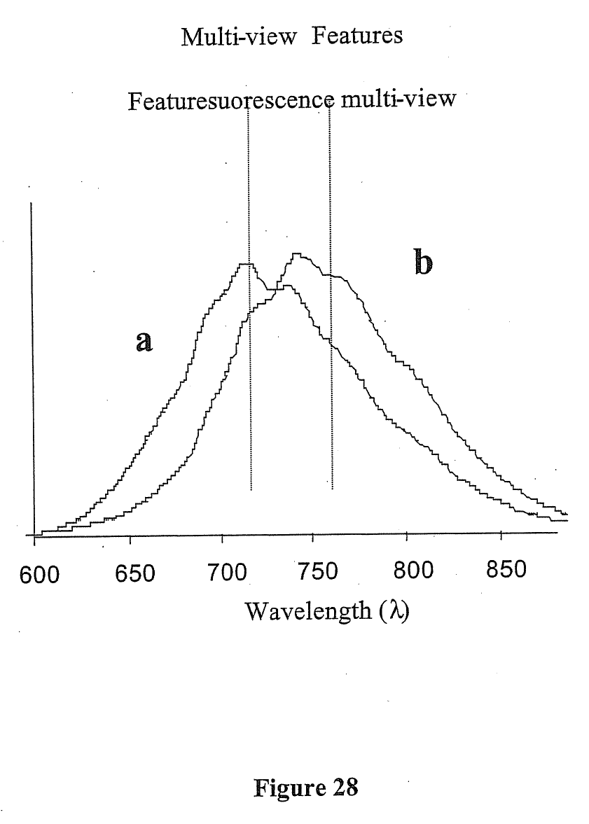

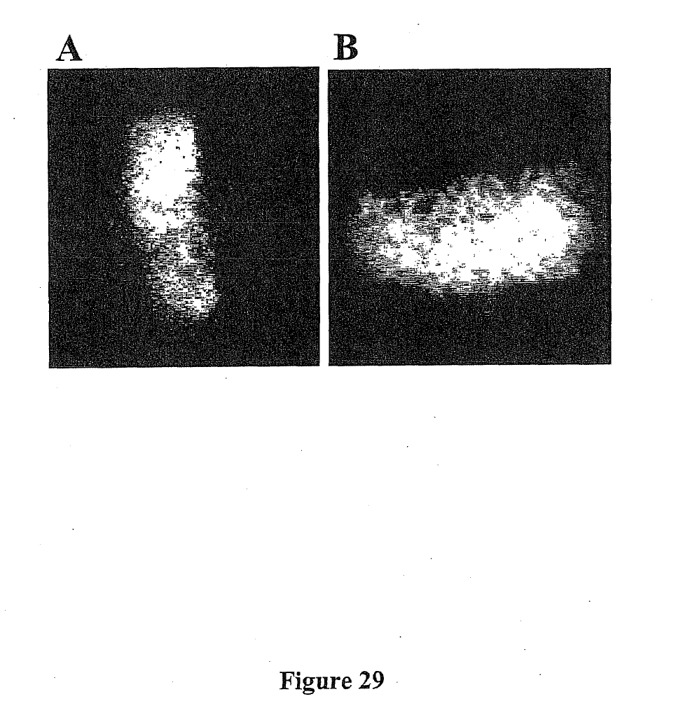

This example describes the general setup and analysis for microscopic fluorescence imaging of inks. A microscope with a mercury light source in the reflectance mode constitute the base platform of this multi-view set-up. An interchangeable fluorescence cube composed of a 420 nm excitation filter, 420 nm dichroic mirror and a 430 nm band pass filter was placed between the optic lens and the multi-view selector to ensure that wavelengths of light greater than 430 nm were transmitted, thus minimizing stray light from the illumination source during collection by the multi-view selector. Multi-view images were acquired by tuning the electro-optic imaging spectrometer through a range of wavelengths from 440 nm to 720 nm in 5 nm increments. The fluorescence intensity from the pixels of the two different inks show distinct characteristics as shown in FIG. 28. The multi-view characteristic A is characteristic of the pixels in the vertical ink line shown in FIG. 28 while the curve B is characteristic of the pixels in the horizontal ink line. An image reconstruction is shown in FIG. 29. Image 29A highlights all pixels with a type multi-view characteristics of 28A while image 29B pinpoints the multi-view characteristics of 28B. Note that some mixing of inks is seen in 29B, which can be relevant to the nature and time line of this forensic event. This example demonstrates multi-view imaging as an efficient characterization method for ink discrimination and characterization.

### Multi-Layer Paint Fragments

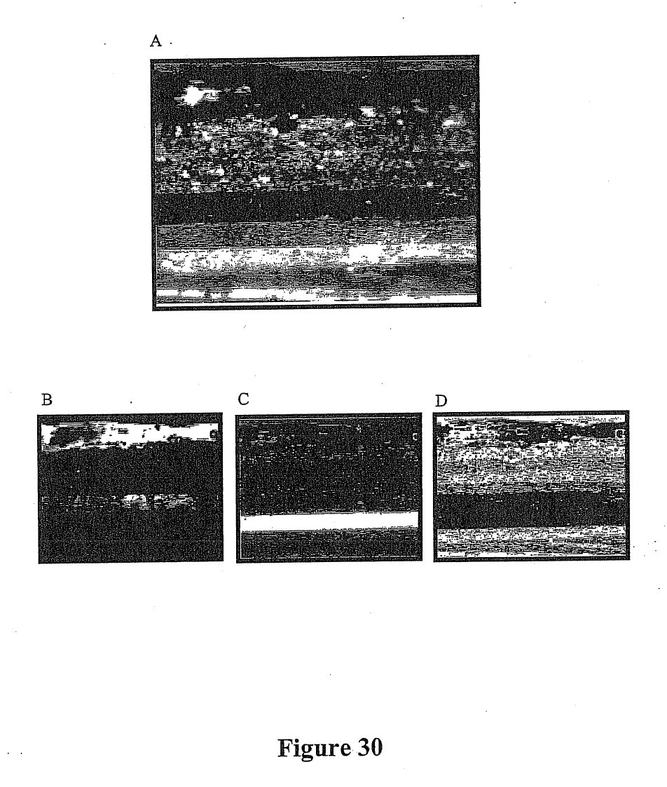

This example describes the general setup and analysis for fluorescence multi-view imaging of multi-layered paint fragments on a microscopic platform. A microscope with a tungsten-quartz-halogen light source in the reflectance mode constitutes the base of the instrument setup. The brightfield reflectance digital image of the paint sample is shown in FIG. 30A. Multi-view images were acquired by electrically controlling the electro-optic tunable filter through a range of wavelengths from 400 nm to 720 nm in 5 nm increments. The corresponding reflected wavelengths seen in a few multi-view results are shown in FIGS. 30B (400 nm), 30C (550 nm) and 30D (690 nm) that accentuate different paint layers and subtle features within layers where certain wavelengths of light are reflected. The choice of the range of wavelengths used for the final multi-view analysis and comparison to known samples depends on the colors in the sample.

Many modifications and variations of the present invention are possible in light of the above teachings. It is therefore to be understood that, within the scope of the appended claims, the invention may be practiced otherwise than as specifically described.

We claim:

1. A method, comprising:
a) illuminating nondestructively a forensic sample with light of a first wavelength λ₁; then
b) imaging a first image of the forensic sample using the light emitted from the sample at a second wavelength λ₂, the second wavelength filtered by an electro-optical tunable filter; then
c) imaging a second image of the forensic sample using the light emitted from the sample at a third wavelength λ₃ different from λ₂, the third wavelength filtered by an electro-optical tunable filter; then
d) creating a calculated image of the forensic sample from the first image and the second image, wherein said calculated image is a spatially accurate wavelength-resolved image.

2. The method of claim 1, further comprising correcting the calculated image using signals extracted from at least one of the first and second images, the signal extracted from a subset of pixels from at least one of the first and second image pixels.

3. The method of claim 2, wherein the subset of at least one of the first and second image pixels is a subset chosen outside an area of interest of the at least one of the first and second images.

4. The method of claim 3, wherein the correcting of the calculated image comprises subtracting a background signal provided by light of a wavelength λ from outside an area of interest from the image formed by light of wavelength λ₃ and λ₂ where λ is λ₃ or λ₂ or another wavelength.

5. The method of claim 1, wherein the forensic sample is an object carrying a suspected fingerprint.

6. The method of claim 5, further comprising correcting the calculated image using signals extracted from at least one of the first and second images, the signal extracted from a subset of pixels from at least one of the first and second images.

7. The method of claim 6, wherein the subset of at least one of the first and second image pixels is a subset chosen outside the area of the suspected fingerprint.

8. The method of claim 7, wherein the correcting of the calculated image comprises subtracting a background signal provided by light of a wavelength λ from outside the area of the suspected fingerprint from the image formed by light of wavelength λ₃ and λ₂, where λ is λ₃ or λ₂ or another wavelength.

9. The method of claim 1, wherein the forensic sample is an object carrying ink.

10. The method of claim 9, further comprising correcting the calculated image using signals extracted from at least one of the first and second images, the signal extracted from a subset of pixels from at least one of the first and second images.

11. The method of claim 10, wherein the subset of at least one of the first and second image pixels is a subset chosen outside the area of the ink.

12. The method of claim 11, wherein the correcting of the calculated image comprises subtracting a background signal provided by light of a wavelength λ from outside the area of ink from the images formed by light of wavelength λ₃ and λ₂, where λ is λ₃ or λ₂ or another wavelength.

13. The method of claim 1, wherein the forensic sample is an object carrying suspected gunshot residue.

14. The method of claim 13, further comprising correcting the calculated image using signals extracted from at least one of the first and second images, the signal extracted from a subset of pixels from at least one of the first and second images.

15. The method of claim 14, wherein the subset of at least one of the first and second image pixels is a subset chosen outside the area of interest of the suspected gunshot reside.

16. The method of claim 15, wherein the correcting of the calculated image comprises subtracting a background signal provided by light of a wavelength λ from outside the area of the suspected gunshot residue from the images formed by light of wavelength λ₃ and λ₂, where λ is λ₃ or λ₂ or another wavelength.

17. The method of claim 1, wherein the forensic sample is an object carrying a suspected condom lubricant.

18. The method of claim 17, further comprising correcting the calculated image using signals extracted from at least one of the first and second images, the signal extracted from a subset of pixels from at least one of the first and second images.

19. The method of claim 18, wherein the subset of at least one of the first and second image pixels is a subset chosen outside the area of the suspect condom lubricant.

20. The method of claim 19, wherein the correcting of the calculated image comprises subtracting a background signal provided by light of a wavelength λ from outside the area of the suspected condom lubricant from the images formed by light of wavelength λ₃ and λ₂, where λ is λ₃ or λ₂ or another wavelength.

21. The method of claim 1, wherein the forensic sample is a multilayer paint chip.

22. The method of claim 21, further comprising correcting the calculated image using signals extracted from at least one of the first and second images, the signal extracted from a subset of pixels from at least one of the first and second images.

23. The method of claim 22, wherein the subset of at least one of the first and second image pixels is a subset chosen outside the area of interest in the multiplayer paint chip.

24. The method of claim 23, wherein the correcting of the calculated image comprises subtracting a background signal provided by light of a wavelength λ from outside the area of interest from the image formed by light of wavelength λ₃ and λ₂, where λ is λ₃ or λ₂ or another wavelength.

25. The method of claim 1, wherein the forensic sample is a fiber.

26. The method of claim 25, further comprising correcting the calculated image using signals extracted from at least one of the first and second images, the signal extracted from a subset of pixels from at least one of the first and second images.

27. The method of claim 26, wherein the subset of at least one of the first and second image pixels is a subset chosen outside the area of interest of the fiber.

28. The method of claim 27, wherein the correcting of the calculated image comprises subtracting a background signal provided by light of a wavelength λ from outside the area of the fiber from the images formed by light of wavelength λ₃ and λ₂, where λ is λ₃ or λ₂ or another wavelength.

29. The method of claim 1, wherein the forensic sample is a thin layer chromatography plate.

30. The method of claim 29, further comprising correcting the calculated image using signals extracted from at least one of the first and second images, the signal extracted from a subset of pixels from at least one of the first and second images.

31. The method of claim 30, wherein the subset of at least one of the first and second image pixels is a subset chosen outside the area of interest on the thin layer chromatography plate.

32. The method of claim 31, wherein the correcting of the calculated image comprises subtracting a background signal provided by light of a wavelength λ from outside the area of interest from the images formed by light of wavelength λ₃ and λ₂, where λ is λ₃ or λ₂ or another wavelength.
